(19) United States
(12) Patent Application Publication
(10) Pub. No.: US 2015/0130317 A1
(43) Pub. Date: May 14, 2015

(54) ROTOR AND MOTOR USING THE SAME

(71) Applicant: HON HAI PRECISION INDUSTRY CO., LTD., New Taipei (TW)

(72) Inventors: PO-CHANG HUNG, New Taipei (TW); YUH-SHYUAN HUANG, New Taipei (TW); SHIH-HSIN HSU, New Taipei (TW)

(21) Appl. No.: 14/539,008

(22) Filed: Nov. 12, 2014

(30) Foreign Application Priority Data
Nov. 12, 2013 (TW) 102141145

(51) Int. Cl. H02K 1/27

(52) U.S. Cl. CPC H02K 1/274
USPC 310/156.12

(57) ABSTRACT

A rotor includes a rotor body and a plurality of permanent magnet received in the rotor body. The rotor body separately defines a plurality of recess troughs on an outer wall of the rotor body. Side surfaces of each recess trough include a bottom surface and two side surfaces. The bottom surface is coupled between the two side surfaces. The bottom surface is a planar surface, and each side surface is a curved surface. The rotor body further defines a plurality of receiving grooves around a circumferential direction of the rotor body and extends along the vertical axis of the rotor body. Each receiving groove receives at least one permanent magnet. Each two adjacent receiving grooves are positioned under one bottom surface, and sidewalls of each two adjacent receiving grooves and the corresponding one bottom surface cooperatively form a T-shaped region.

### FIELD

The present disclosure relates generally to rotors, and especially to a rotor having buried permanents and a motor using the rotor.

### BACKGROUND

A motor generally includes a rotor and a stator. The stator generates an alternative magnetic field to drive the rotor rotate.

### BRIEF DESCRIPTION OF THE DRAWINGS

Implementations of the present technology will now be described, by way of example only, with reference to the attached figures.

FIG. 1 is a top plan view of an embodiment of a motor with recess troughs on an outer wall of the motor.

FIG. 2 is an enlarged and partial view of the motor of FIG. 1.

FIG. 3 illustrates a chart of a numerical simulation opposing electromotive force distribution of the motor shown in FIG. 1 and a traditional motor, and the traditional motor having a similar structure with the motor shown in FIG. 1, but without recess troughs on an outer wall of the traditional motor.

FIG. 4 illustrates a chart of a numerical simulation output torque distribution of the motor shown in FIG. 1 and a traditional motor, and the traditional motor having a similar structure with the motor shown in FIG. 1, but without recess troughs on an outer wall of the traditional motor.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A rotor can include a rotor body and a plurality of permanent magnet received in the rotor body. The rotor body separately can define a plurality of recess troughs on an outer wall of the rotor body. Side surfaces of each recess trough can include a bottom surface and two side surfaces. The bottom surface can be coupled between the two side surfaces. The bottom surface can be a planar surface, and each side surface can be a curved surface. The rotor body further can define a plurality of receiving grooves around a circumferential direction of the rotor body and extends along the vertical axis of the rotor body. Each receiving groove can receive at least one permanent magnet. Each two adjacent receiving grooves can be positioned under one bottom surface, and sidewalls of each two adjacent receiving grooves and the corresponding one bottom surface can cooperatively form a T-shaped region. The disclosure can also provide a motor using the rotor.

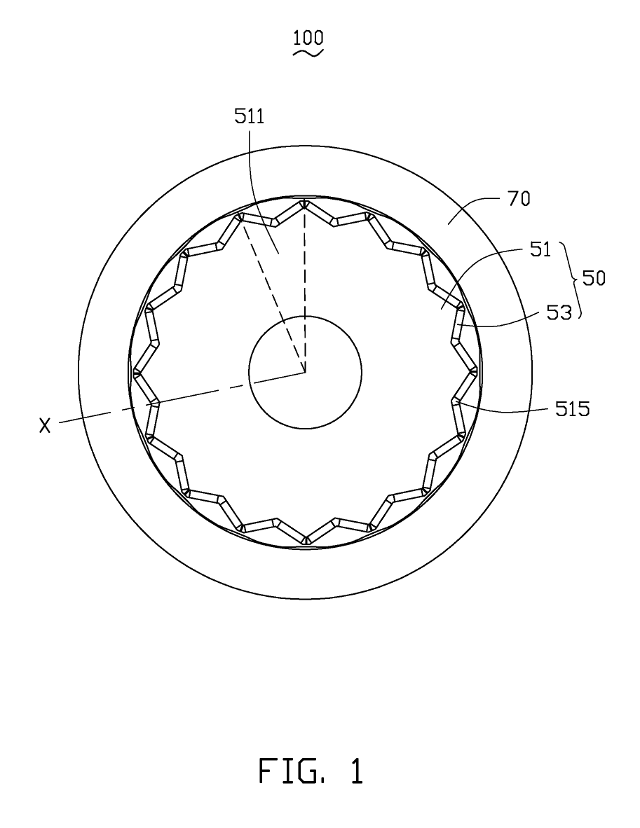

Referring to FIG. 1, a motor 100 can include a rotor 50 and a stator 70 sleeved on the rotor 50. The motor 100 can further include other structures, such as a rotary shaft. In an illustrated embodiment, the other structures of the motor 100 are not described here, for simplification.

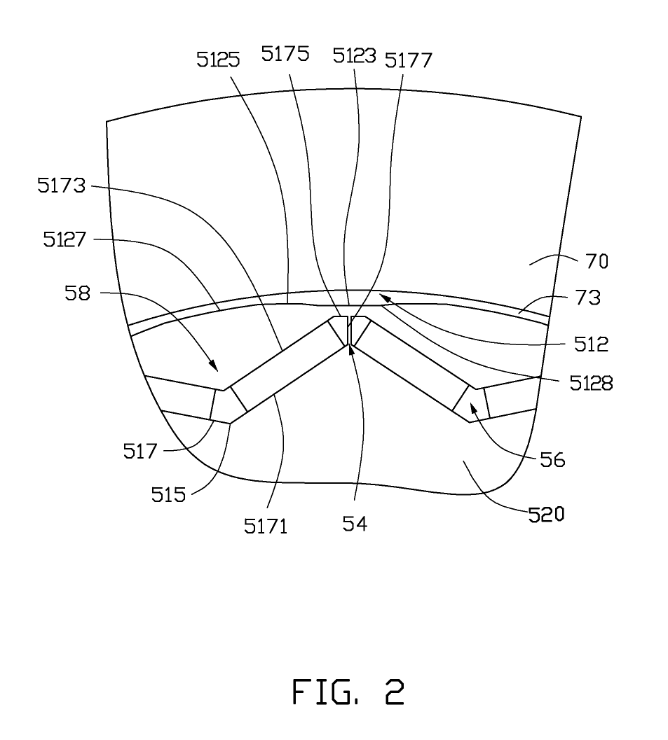

The rotor 50 can include a rotor body 51 and a plurality of permanent magnets 53 received in the rotor body 51. The rotor body 51 can be substantially in a cylindrical shape. Also referring to FIG. 2, a plurality of recess troughs 512 can be separately recessed on an outer wall of the rotor body 51, and extend along a direction parallel to a vertical axis of the rotor body 51. Each recess trough 512 can include a bottom surface 5123 and two side surfaces 5125. The bottom surface 5123 can interconnect the two side surfaces 5125. The bottom surface 5123 can be a planar surface. The two side surfaces 5125 can be curved surfaces. The outer wall of the rotor body 51 can further include a plurality of connecting surfaces 5127. Each connecting surface 5127 can be positioned two adjacent recess troughs 512 and interconnect with two side surfaces 5125 of the two adjacent recess troughs 512. In an illustrated embodiment, all of the side surface 5125 and the connecting surfaces 5127 are arc curved surfaces. A radius of each connecting surface 5127 can be equal to an ex-radius of the rotor body 51, and a radius of each side surface 5125 can be greater than the radius of each connecting surface 5127. A first joint 5128 can be formed by the bottom surface 5123 and one respective adjacent side surface 5125. In other embodiments, each connecting surface 5127 can be designed to be a symmetrical curved surface, a distance between a highest position of the connecting surface 5127 and the vertical axis of the rotor body 51 is equal to the ex-radius of the rotor body 51. The connecting surfaces 5127 can be positioned to be other curved surfaces or planar surfaces.

A plurality of receiving grooves 515 can be separately defined in the rotor body 51 around a circumferential direction of the rotor body 51 and extend along a direction parallel to the vertical axis of the rotor body 51. Two adjacent receiving grooves 515 can be positioned under one respective bottom surface 5123. Adjacent sidewalls of each of the two adjacent receiving grooves 515 can be face toward each other. A T-shaped region 54 can be cooperatively formed by one bottom surface 5123 and sidewalls of two respective receiving grooves 515, such that the T-shaped region 54 can be easily achieved magnetic saturation. In the illustrated embodiment, each receiving groove 515 can be substantially positioned to be in a V-shape. Each receiving groove 515 can include two substantially symmetrical receiving portions 517. Each receiving portion 517 can be cooperatively formed by a first sidewall 5171, a second sidewall 5173, a third sidewall 5175, and a fourth sidewall 5177. The first sidewall 5171 and the second sidewall 5173 can be substantially in parallel to each other. The third sidewall 5175 and the fourth sidewall 5177 can be positioned at one end of the receiving portion 517 away from another receiving portion 517 of the same one receiving groove 515. The third sidewall 5175 can interconnect with the second sidewall 5173 and the fourth sidewall 5177. The fourth sidewall 5177 can interconnect with the third sidewall 5175 and the first sidewall 5171. The third sidewall 5175 can be substantially perpendicular to the fourth sidewall 5177. The third sidewall 5175 can be adjacent to and substantially parallel to the respective bottom surface 5123. The first sidewalls 5171 of each receiving groove 515 can be coupled to each other and cooperatively form a V-shaped structure. The second sidewalls 5173 of each receiving groove 515 can be coupled to each other and cooperatively form a V-shaped structure. The fourth sidewalls 5177 of each two adjacent receiving grooves 515 can be substantially in parallel. The third sidewall 5175 and the fourth sidewall 5177 of each two adjacent receiving grooves 515, the , and the respective bottom surface 5123 opposite to the adjacent two receiving grooves 515 can cooperatively form the T-shaped region 54.

Each permanent magnet 53 can be fixedly received in the corresponding receiving portion 517. Permanent magnets 53 mounted in adjacent receiving grooves 515 can have opposite polarities. A rotor segment 520 can be defined, which is positioned in the rotor body 51 at one side of the permanent magnets 53 away from the outer wall of the rotor body 51. Space of each receiving portion 517 can be greater than a bulk of one permanent magnet 53, then air or non magnetic material can be filled in for forming a flux barrier region 56 to prevent magnetic short circuit from occurring inside of the rotor segment 520 past the permanent magnet 53. A pole shoe 58 can be formed between sidewalls of each receiving groove 515 and the outer wall of the rotor body 51. A density of magnetic flux in the flux barrier region 56 is easily to achieve magnet saturation because an area of the flux barrier region 56 is small relative to an area of the entire cross section of the rotor body 51. Therefore, the magnetic flux will be concentrated and distributed in the pole shoe 58. In the illustrated embodiment, the permanent magnets 53 are bar magnets. The first joint 5128 can be positioned on an extension line of one side wall of corresponding one permanent magnet 53 adjacent to the third sidewall 5175 of the cross section of the rotor 50.

An air gap 73 can be formed between an inner wall of the stator 70 and the outer wall of rotor body 51. Distances between the outer wall of the rotor body 51 and the inner wall of the stator 70 can be different because the plurality of recess troughs are recessed in an outer wall of the rotor body 51. A smallest vertical air gap distance between one connecting surface 5127 and a corresponding one inner wall of stator 70 can be less than a vertical distance between the inner wall of the stator 70 and one bottom surface 5123 about 1.1 mm.

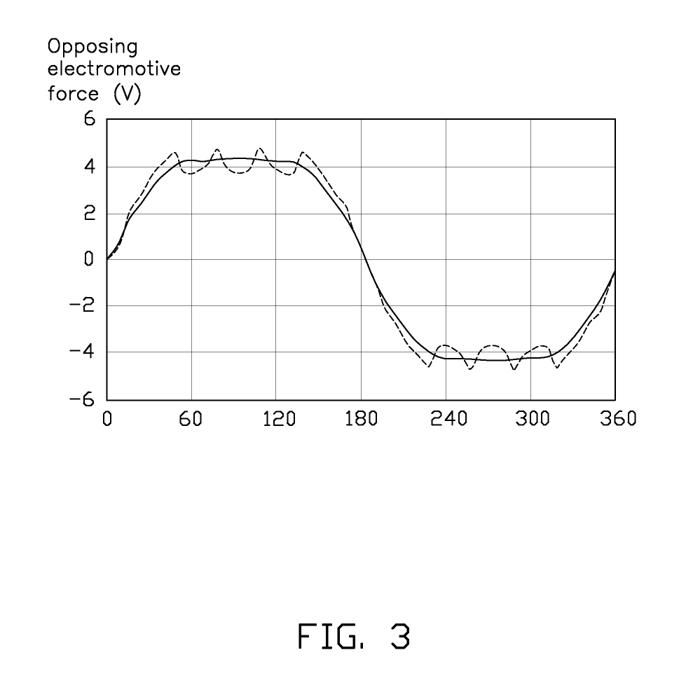

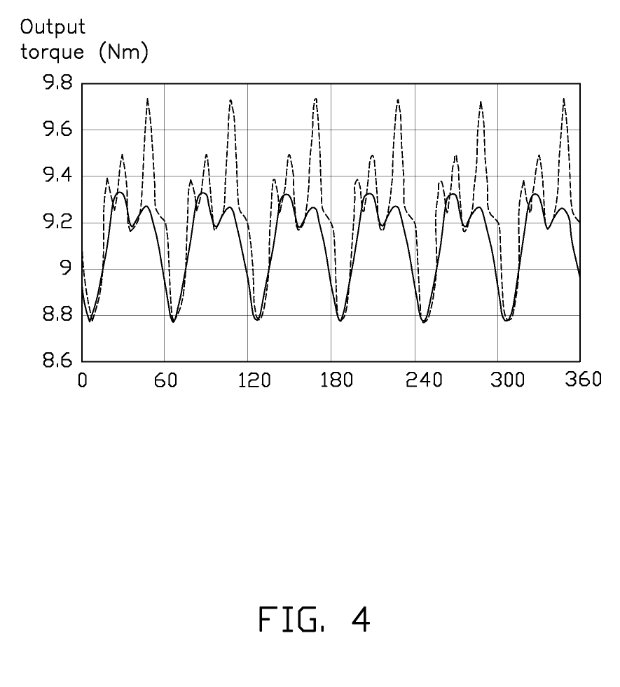

A traditional motor (not shown) is used here for comparing with the motor 100. A structure of the traditional motor is similar to the motor 100, but a difference is that a traditional rotor of the traditional motor has no recess on an outer wall of a rotor of the traditional motor. As shown in FIG. 2, an area of the T-shaped region 54 is less than, an area of original area of the traditional rotor without recesses. Magnetic flux can be concentrated and distributed in the pole shoe 58 and then past to the stator 70. Distances between the outer wall of the rotor body 51 and the inner wall of the stator 70 can be different because the plurality of recess troughs are recessed in the outer wall of the rotor body 51. Magnetic flux can be easily concentrated and distributed in air gaps having a less area. Opposing electromotive force distributions of the motor 100 and the traditional motor without recesses are shown in FIG. 3, the opposing electromotive force distribution of the motor 100 is shown in a solid line, and an opposing electromotive force distribution of traditional motor is shown in a dashed line. Output torque distributions of the motor 100 and the traditional motor without recesses are shown in FIG. 4, the output torque distribution of the motor 100 is shown in a solid line, and an output torque distribution of traditional motor is shown in a dashed line. The data is obtained via finite element analysis using ANSYS software. Referring to the FIGS. 3 and 4, compared with the traditional motor, the motor 100 can obtain more smooth opposing electromotive force distribution and output torque distribution, it means that noise and vibrate problems of the motor 100 can be achieved.

In at least one embodiment, a shape of the receiving groove 515 is not limited in a V shape, and it can designed to be other shapes, such as a slot groove. A substantially T-shaped region 54 can be cooperatively formed by the sidewalls of receiving grooves 515 and the bottom surface 515.

In at least one embodiment, the first sidewall 5171 and the second sidewall 5173 can be not substantially in parallel to each other, the third sidewall 5175 can be not substantially perpendicular to the fourth sidewall 5177. One bottom surfaces 5123, each two corresponding adjacent third sidewalls 5175, and two corresponding adjacent fourth sidewalls 5127 cooperatively formed a substantially T-shaped region 54.

In at least one embodiment, no space can be left while a permanent magnet 53 is received in corresponding one the receiving portion 517.

The embodiments shown and described above are only examples. Many details are often found in the art such as other features of a stator. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A rotor comprising:
a rotor body defining a plurality of recess troughs on an outer wall of the rotor body, each recess trough of the plurality of recess troughs comprising a planar bottom surface interconnecting two curved side surfaces, the rotor body further defining a plurality of receiving grooves around a circumferential direction of the rotor body, each receiving groove of the plurality of receiving grooves extending along a direction parallel to a vertical axis of the rotor body; and
a plurality of permanent magnets received in the rotor body, and each receiving groove of the plurality of receiving grooves receiving at least one of the plurality of permanent magnets,
wherein adjacent receiving grooves of the plurality of receiving grooves are positioned under a corresponding bottom surface of one of the plurality of recess troughs, and sidewalls of the adjacent receiving grooves and the corresponding bottom surface of one of the plurality of recess troughs cooperatively form a substantially T-shaped region.

2. The rotor of claim 1, wherein each receiving groove comprises two symmetrical receiving portions, and the two receiving portions cooperative form a V-shaped structure, and each receiving portion receives one permanent magnet.

3. The rotor of claim 2, wherein each receiving portion is cooperatively formed by a first sidewall, a second sidewall, a third sidewall, and a fourth sidewall, the third sidewall and the fourth sidewall are positioned at one end of the receiving portion away from another receiving portion of the same one receiving groove, the third sidewall interconnect the second sidewall and the fourth sidewall, the fourth sidewall interconnect the third sidewall and the first sidewall, the third sidewall is adjacent to and substantially parallel to the respective bottom surface, the first sidewalls of each receiving groove is coupled to each other and cooperative form a V-shaped structure, and the second sidewalls of each receiving groove is coupled to each other and cooperative form a V-shaped structure.

4. The rotor of claim 3, wherein adjacent two fourth sidewalls are parallel to each other.

5. The rotor of claim 3, wherein the third sidewall of each receiving portion is perpendicular to the respective fourth sidewall.

6. The rotor of claim 3, wherein the first sidewall of each receiving portion and the second sidewall is in parallel to each other.

7. The rotor of claim 3, wherein a first joint is formed by the bottom surface and one respective adjacent side surface, and a first joint is positioned on an extension line of one side wall of corresponding one permanent magnet adjacent to the third sidewall of the cross section of the rotor.

8. The rotor of claim 2, wherein space of each receiving portion is greater than a bulk of one permanent magnet, then air or non magnetic material is filled in for forming a flux barrier region to prevent magnetic short circuit.

9. A motor comprising:
a stator;
a rotor body rotatably received in the stator, the rotary body defining a plurality of recess troughs on an outer wall of the rotor body, each recess trough of the plurality of recess troughs comprising a planar bottom surface interconnecting two curved side surfaces, the rotor body further defining a plurality of receiving grooves around a circumferential direction of the rotor body, each receiving groove of the plurality of receiving grooves extending along a direction parallel to a vertical axis of the rotor body; and
a plurality of permanent magnets received in the rotor body, and each receiving groove of the plurality of receiving grooves receiving at least one of the plurality of permanent magnets,
wherein adjacent receiving grooves of the plurality of receiving grooves are positioned under a corresponding bottom surface of one of the plurality of recess troughs, and sidewalls of the adjacent receiving grooves and the corresponding bottom surface of one of the plurality of recess troughs cooperatively form a substantially T-shaped region.

10. The motor of claim 9, wherein an air gap is formed between an inner wall of the stator and the outer wall of rotor body, a smallest vertical air gap distance between one connecting surface and a corresponding one inner wall of stator is less than a vertical distance between the inner wall of the stator and one bottom surface about 1.1 mm.

11. The motor of claim 9, wherein each receiving groove comprises two symmetrical receiving portions, and the two receiving portions cooperative form a V-shaped structure, and each receiving portion receives one permanent magnet.

12. The motor of claim 11, wherein each receiving portion is cooperatively formed by a first sidewall, a second sidewall, a third sidewall, and a fourth sidewall, the third sidewall and the fourth sidewall are positioned at one end of the receiving portion away from another receiving portion of the same one receiving groove, the third sidewall interconnect the second sidewall and the fourth sidewall, the fourth sidewall interconnect the third sidewall and the first sidewall, the third sidewall is adjacent to and substantially parallel to the respective bottom surface, the first sidewalls of each receiving groove is coupled to each other and cooperative form a V-shaped structure, and the second sidewalls of each receiving groove is coupled to each other and cooperative form a V-shaped structure.

13. The motor of claim 12, wherein adjacent two fourth sidewalls are parallel to each other.

14. The motor of claim 12, wherein the third sidewall of each receiving portion is perpendicular to the respective fourth sidewall.

15. The motor of claim 12, wherein the first sidewall of each receiving portion and the second sidewall is in parallel to each other.

16. The motor of claim 12, wherein a first joint is formed by the bottom surface and one respective adjacent side surface, and a first joint is positioned on an extension line of one side wall of corresponding one permanent magnet adjacent to the third sidewall of the cross section of the rotor.

17. The motor of claim 12, wherein space of each receiving portion is greater than a bulk of one permanent magnet, then air or non magnetic material is filled in for forming a flux barrier region to prevent magnetic short circuit.
